(19) United States
(12) Patent Application Publication
(10) Pub. No.: US 2025/0218058 A1
(43) Pub. Date: Jul. 3, 2025

(54) INFORMATION PROCESSING APPARATUS

(71) Applicant: NTT DOCOMO, INC., Tokyo (JP)

(72) Inventors: Nobutaka MATSUSHIMA, Chiyoda-ku (JP); Kensuke UEDA, Chiyoda-ku (JP); Yuuichi MIZUKOSHI, Chiyoda-ku (JP)

(73) Assignee: NTT DOCOMO, INC., Tokyo (JP)

(21) Appl. No.: 18/701,670

(22) PCT Filed: Oct. 28, 2022
(86) PCT No.: PCT/JP2022/040377

§ 371 Date: Mar. 21, 2025

(30) Foreign Application Priority Data
Nov. 15, 2021 (JP) 2021-185387

(51) Int. Cl. G06T 11/00; G06F 3/01; G06T 7/215; G06T 7/246; G06T 7/73

(52) U.S. Cl. CPC G06T 11/00; G06F 3/012; G06F 3/013; G06T 7/215; G06T 7/251; G06T 7/73; G06T 2207/20104; G06T 2207/20132

(57) ABSTRACT

A mobile apparatus includes a first acquirer, a first generator and an image processor. The first acquirer acquires (i) movement information about movement of a user to which a pair of AR glasses is mounted at the user's head, and (ii) image information indicating an image captured by a first image capture device mounted to the pair of AR glasses. The first generator controls a position in the captured image, at which the captured image is partially cropped, in accordance with the movement information; and generates, by controlling the position in the captured image, a partial image cropped from the captured image. The image processor performs image processing on the partial image.

### TECHNICAL FIELD

The present invention relates to information processing apparatuses.

### BACKGROUND ART

A pair of XR glasses adopting an XR technology has become widely used. Representative examples of the XR technology include augmented reality (AR), virtual reality (VR), and mixed reality (MR) technologies. The exemplary use and application of a pair of XR glasses include work assistance. Specifically, in conducting work, a worker wears a pair of XR glasses on which information about the details of the work is displayed. For example, Patent Document 1 listed below discloses a maintenance support system that assists work to be conducted when a part failure has occurred in an electronic device facility. The maintenance support system notifies a pair of AR glasses worn by a maintenance person of information about a substitution for a failed part and a message that the failed part is replaceable.

### RELATED ART DOCUMENT

### Patent Document

Patent Document 1: Japanese Patent Application Laid-Open Publication No. 2020-170249

### SUMMARY OF THE INVENTION

### Problem to be Solved by the Invention

Services using a pair of XR glasses need recognition of a real space situation based on an image captured by a camera incorporated in the pair of XR glasses and various kinds of processing according to the real space state (e.g., presentation of information according to a real space situation). Since the real space state changes moment by moment, high-speed processing is required for providing a service reflecting a real-time state. However, hardware has finite computation resources. In order to perform processing at high speed, preferably, computational complexity is reduced as much as possible.

An object of the present invention is to provide an information processing apparatus that performs processing based on an image more efficiently.

### Means for Solving the Problems

An information processing apparatus according to an aspect of this invention includes: (i) an acquirer configured to acquire (i-a) movement information about movement of a user to which an image capture device is mounted at the head of the user, and (i-b) image information indicating an image captured by the image capture device; (ii) a generator configured to control a position in the captured image, at which the captured image is partially cropped, in accordance with the movement information, and generate, by controlling the position in the captured image, a partial image cropped from the captured image; and (iii) an image processor configured to perform image processing on the partial image.

### Effects of the Invention

According to an aspect of this invention, processing based on an image can be performed efficiently as compared with a case in which a captured image is subjected to processing as a whole.

### BRIEF DESCRIPTION OF THE DRAWINGS

FIG. 1 is a view illustrating an outline of an information processing system 1 according to a first embodiment.

FIG. 2 is a block diagram illustrating a configuration of the information processing system 1 according to the first embodiment.

FIG. 3 is an explanatory view illustrating an appearance of a pair of AR glasses 10A.

FIG. 4 is a block diagram illustrating a configuration of the pair of AR glasses 10A.

FIG. 5 is a block diagram illustrating a configuration of a mobile apparatus 20A.

FIG. 6 is a front view of an apparatus DV1.

FIG. 7 is a diagram illustrating a relationship between the apparatus DV1 and an X-Y coordinate system on a real space.

FIG. 8 is a diagram illustrating a relationship between a captured image PC showing the apparatus DV1 and an x-y coordinate system.

FIG. 9 is a flowchart illustrating procedures for a processor 206.

FIG. 10 is a block diagram illustrating a configuration of an information processing system 2 according to a second embodiment.

FIG. 11 is a block diagram illustrating a configuration of a pair of AR glasses 10B.

FIG. 12 is a block diagram illustrating a configuration of a mobile apparatus 20B.

FIG. 13 is a diagram schematically illustrating a visual field range of a user U.

FIG. 14 is a diagram schematically illustrating the visual field range of the user U.

FIG. 15 is a front view of an apparatus DV2.

FIG. 16 is a diagram illustrating an example of a positional relationship between a captured image PC and the visual field range of the user U.

FIG. 17 is a diagram illustrating another example of the positional relationship between the captured image PC and the visual field range of the user U.

FIG. 18 is a flowchart illustrating procedures for a processor 206.

### MODES FOR CARRYING OUT THE INVENTION

### A. First Embodiment

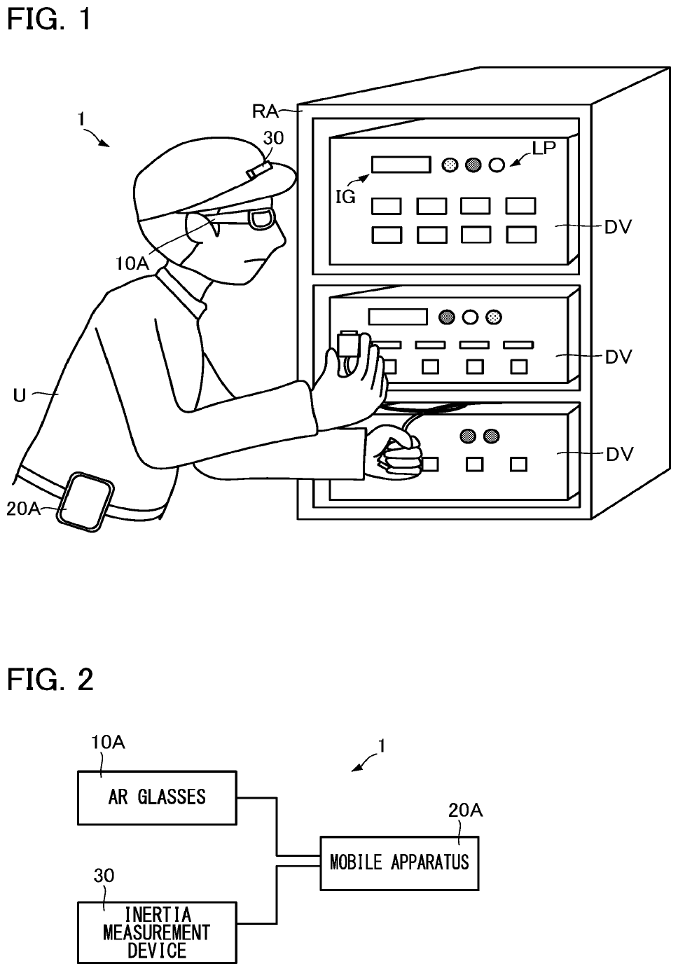

With reference to FIGS. 1 to 9, a description will be given of a configuration of an information processing system 1 including an information processing apparatus according to a first embodiment of this invention.

### A-1. System Configuration

FIG. 1 is a view illustrating an outline of the information processing system 1 according to the first embodiment. FIG. 2 is a block diagram illustrating the configuration of the information processing system 1 according to the first embodiment. The information processing system 1 includes a pair of AR glasses 10A mountable to the head of a user U, a mobile apparatus 20A which the user U carries, and an inertia measurement device 30 that measures the movement of the head of the user U. As will be described later, the pair of AR glasses 10A includes a first image capture device 124A. In other words, the first image capture device 124A is mounted to the head of the user U. The mobile apparatus 20A is an example of an information processing apparatus.

In the embodiment, the information processing system 1 assists work to be conducted by the user U, by image processing using artificial intelligence (AI). For example, the user U wires apparatuses DV housed in a rack RA. If a connector is inserted into a wrong port by the user U, a level of an indicator IN or a lighting state of a lamp LP may differ from that in a usual state. For this reason, the information processing system 1 monitors the level of the indicator IN, the lighting state of the lamp LP of each apparatus DV, by the image processing using AI. In the following description, the term “monitoring target” refers to a target (e.g., the indicator IN, and the lamp LP) to be monitored by the information processing system 1. In the embodiment, the monitoring target shows an operating state of a corresponding one of the apparatuses DV. When the monitoring target turns into a display state different from a usual state, the information processing system 1 notifies the user U of this display state through the pair of AR glasses 10A. This notice reduces a degree of the user U's attention to the monitoring target, and the user U is thus able to concentrate on the wiring work.

In some cases, two or more apparatuses DV differ in type from each other. The apparatuses DV also differ from each other in respect of an arrangement of the indicator IN and the lamp LP on a console, as well as the level of the indicator IN and the lighting color of the lamp LP in the usual state. Using AI, a monitoring target in an image may be identified and may be subjected to a determination whether the monitoring target is in a usual state, even in an environment in which different types of apparatuses DV coexist.

### A-2. Pair of AR Glasses 10A

The pair of AR glasses 10A is a wearable display of a see-through type mountable to the head of the user U. The pair of AR glasses 10A displays a virtual object on a display panel provided on a left-eye lens 110A and a display panel provided on a right-eye lens 110B, based on control by the mobile apparatus 20A. The pair of AR glasses 10A is an example of an apparatus including the first image capture device 124A. The apparatus including the first image capture device 124A may be, for example, a goggles-type transmission head-mounted display having the same function as the function of the pair of AR glasses 10A.

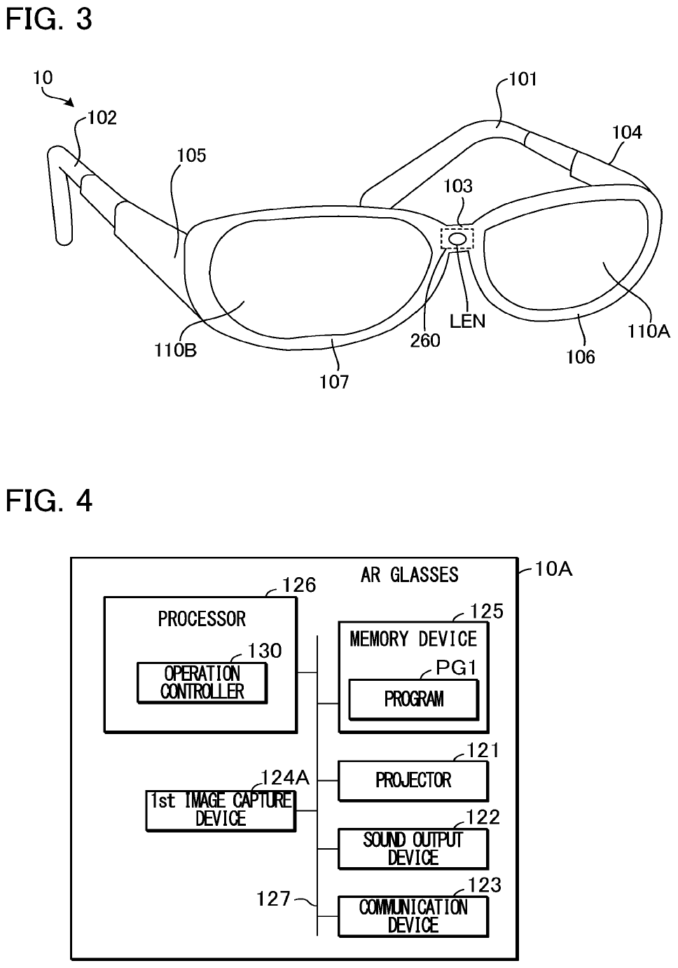

FIG. 3 is an explanatory view illustrating an appearance of the pair of AR glasses 10A. As visually recognized from the appearance, the pair of AR glasses 10A includes temple tips 101 and 102, a nose bridge 103, temples 104 and 105, rims 106 and 107, the lenses 110A and 110B, and an imaging lens LEN.

The imaging lens LEN is disposed on the nose bridge 103. The imaging lens LEN constitutes the first image capture device 124A illustrated in FIG. 4.

The temple 104 is provided with a left-eye display panel and a left-eye optical member. The display panel is, for example, a liquid crystal panel or an organic electro luminescence (EL) panel. The left-eye display panel displays an image, based on, for example, control by the mobile apparatus 20A (to be described later). The left-eye optical member is an optical member that guides light emitted from the left-eye display panel, to the lens 110A. The temple 104 is provided with a sound output device 122 (to be described later).

The temple 105 is provided with a right-eye display panel and a right-eye optical member. The right-eye display panel displays the image, based on, for example, the control by the mobile apparatus 20A. The right-eye optical member is an optical member that guides light emitted from the right-eye display panel, to the lens 110B. The temple 105 is provided with a sound output device 122 (to be described later).

The rim 106 holds the lens 110A. The rim 107 holds the lens 110B.

The lenses 110A and 110B each have a half mirror. The half mirror of the lens 110A allows light representing a real space to transmit therethrough, thereby guiding the light representing the real space to the left eye of the user U. The half mirror of the lens 110A reflects the light guided by the left-eye optical member, toward the left eye of the user U. The half mirror of the lens 110B allows the light representing the real space to transmit therethrough, thereby guiding the light representing the real space to the right eye of the user U. The half mirror of the lens 110B reflects the light guided by the right-eye optical member, toward the right eye of the user U.

When the user U wears the pair of AR glasses 10A, the lens 110A and lens 110B are respectively located in front of the left eye and right eye of the user U. The user U wearing the pair of AR glasses 10A is able to visually recognize the real space represented by the light transmitted through each of the lenses 110A and 110B and the image projected onto each of the display panels by a projector 121, with the real space superimposed on the image.

FIG. 4 is a block diagram illustrating a configuration of the pair of AR glasses 10A. The pair of AR glasses 10A includes the projector 121, the sound output devices 122, a communication device 123, the first image capture device 124A, a memory device 125, a processor 126, and a bus 127, in addition to the foregoing temple tips 101 and 102, nose bridge 103, temples 104 and 105, rims 106 and 107, lenses 110A and 110B, and imaging lens LEN. The constituents illustrated in FIG. 4 are housed in, for example, the temples 104 and 105. The projector 121, the sound output devices 122, the communication device 123, the first image capture device 124A, the memory device 125, and the processor 126 are connected to each other via the bus 127 so as to exchange information with each other. The bus 127 may be configured with a single bus or may be configured with different buses for elements, such as devices, to be connected to each other.

The projector 121 includes the lens 110A, the left-eye display panel, the left-eye optical member, the lens 110B, the right-eye display panel, and the right-eye optical member. The light representing the real space transmits through the projector 121. The projector 121 displays the image, based on the control by the mobile apparatus 20A. In the embodiment, the image displayed by the projector 121 is, for example, a warning message notified by a notifier 233 (to be described later).

The sound output devices 122 are respectively located on the temples 104 and 105. However, the sound output devices 122 are not necessarily located on the respective temples 104 and 105. For example, one sound output device 122 may be located on one of the temples 104 and 105. Alternatively, one sound output device 122 may be located on at least one of the temple tips 101 and 102. As yet alternative, one sound output device 122 may be located on the nose bridge 103. Each sound output device 122 is, for example, a speaker. Each sound output device 122 is directly controlled by the mobile apparatus 20A or is controlled through the processor 126 of the pair of AR glasses 10A. Each sound output device 122 outputs, for example, a work assistance sound such as an alarm sound for urging the user U to use caution during work. The pair of AR glasses 10A does not necessarily include the sound output devices 122. For example, the sound output devices 122 may be provided separately from the pair of AR glasses 10A.

The communication device 123 communicates with a communication device 203 (see FIG. 4) of the mobile apparatus 20A in a wireless or wired manner. In the embodiment, the communication device 123 communicates with the communication device 203 of the mobile apparatus 20A, using a near-field wireless communication technique such as Bluetooth (registered trademark).

The first image capture device 124A captures an image of a subject, and outputs image information indicating the captured image (hereinafter, “captured image PC”). In the embodiment, the first image capture device 124A is placed to capture an image in the same direction as the direction of the head of the user U. The captured image PC shows an object located forward of the user U (i.e., in the direction of sight of the user U). For example, the captured image PC captured during the work conducted by the user U shows the one or more apparatuses DV housed in the rack RA. The captured image PC generated by the first image capture device 124A is transmitted in the form of image information to the mobile apparatus 20A via the communication device 123. The first image capture device 124A repeatedly captures images at predetermined imaging intervals, and transmits generated image information to the mobile apparatus 20A in every imaging operation.

The first image capture device 124A includes, for example, an imaging optical system and an imaging element. The imaging optical system is an optical system including the at least one imaging lens LEN (see FIG. 3). For example, the imaging optical system may include a variety of optical elements including an optical prism. Alternatively, the imaging optical system may include a zoom lens or a focus lens. Examples of the imaging element include a charge coupled device (CCD) image sensor, and a complementary MOS (CMOS) image sensor.

The memory device 125 is a recording medium to be read by the processor 126. The memory device 125 includes, for example, a nonvolatile memory and a volatile memory. Examples of the nonvolatile memory include a read only memory (ROM), an erasable programmable read only memory (EPROM), and an electrically erasable programmable read only memory (EEPROM). A non-limiting example of the volatile memory is a random access memory (RAM). The memory device 125 stores a program PG1.

The processor 126 comprises one or more central processing units (CPUs). The one or more CPUs are an example of one or more processors. The one or more processors and the one or more CPUs are each an example of a computer.

The processor 126 reads the program PG1 from the memory device 125. The processor 126 runs the program PG1 to thereby function as an operation controller 130. The operation controller 130 may be configured with a circuit such as a digital signal processor (DSP), an application specific integrated circuit (ASIC), a programmable logic device (PLD), or a field programmable gate array (FPGA).

The operation controller 130 controls operation of the pair of AR glasses 10A. For example, the operation controller 130 transmits, to the projector 121, an image display control signal received by the communication device 123 from the mobile apparatus 20A. The projector 121 displays an image indicated by the image display control signal. The operation controller 130 transmits, to the sound output devices 122, an audio output control signal received by the communication device 123 from the mobile apparatus 20A. The sound output devices 122 each output a sound indicated by the audio output control signal. The operation controller 130 transmits, to the mobile apparatus 20A, image information indicating the captured image PC captured by the first image capture device 124A.

### A-3. Mobile Apparatus 20A

The mobile apparatus 20A monitors a target, using the image PC captured by the first image capture device 124A of the pair of AR glasses 10A. The mobile apparatus 20A provides a notification to the user U through the pair of AR glasses 10A in response to detection of an unusual state of the monitoring target. Preferable examples of the mobile apparatus 20A include a smartphone and a tablet.

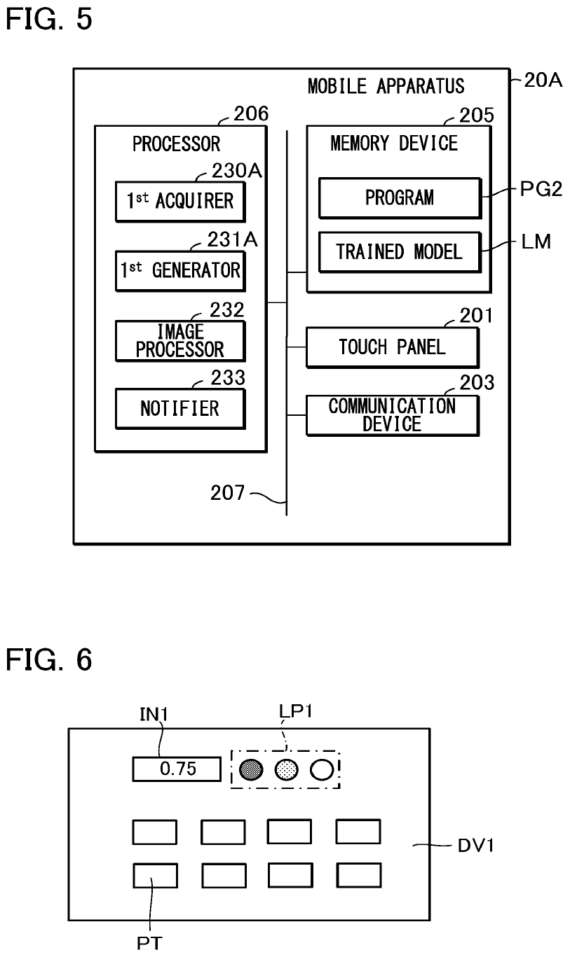

FIG. 5 is a block diagram illustrating a configuration of the mobile apparatus 20A. The mobile apparatus 20A includes a touch panel 201, the communication device 203, a memory device 205, a processor 206, and a bus 207. The touch panel 201, the communication device 203, the memory device 205, and the processor 206 are connected to each other via the bus 207 so as to exchange information with each other. The bus 207 may be configured with a single bus or may be configured with different buses for devices to be connected to each other.

The touch panel 201 displays a variety of information for the user U, and detects touch operation by the user U. The touch panel 201 serves as an input device and an output device. For example, the touch panel 201 has a laminated structure including a display panel, a glass cover plate, and a touch sensor unit interposed between the display panel and the cover glass plate. Examples of the display panel include a liquid crystal display panel and an organic EL display panel. The touch sensor unit is configured to detect the touch operation. When the user U touches the touch panel 201 with a finger, the touch panel 201 periodically detects a contact position on the touch panel 201 where the user U has touched with the finger, and transmits touch information indicating the detected contact position to the processor 206.

The communication device 203 communicates with the communication device 123 (see FIG. 4) of the pair of AR glasses 10A in a wireless or wired manner. In the embodiment, the communication device 203 communicates with the communication device 123, using the same near-field wireless communication technique as that for the communication device 123 of the pair of AR glasses 10A. The communication device 203 also communicates with the inertia measurement device 30 (see FIGS. 1 and 2) in a wireless or wired manner. In the embodiment, the communication device 203 communicates with the inertia measurement device 30, using the near-field wireless communication technique.

The memory device 205 is a recording medium to be read by the processor 206. The memory device 205 includes a nonvolatile memory and a volatile memory. Examples of the nonvolatile memory include a ROM, an EPROM, and an EEPROM. A non-limiting example of the volatile memory is a RAM. The memory device 205 stores a program PG2 and a trained model LM.

The trained model LM learns a state of a monitoring target. More specifically, the trained model LM learns a usual state and an unusual state of a monitoring target by deep learning using a convolutional neural network. In response to input of an image of an appearance of a monitoring target, the trained model LM outputs whether display of the monitoring target is usual. The monitoring target displays an operating state of a corresponding one of the apparatuses DV. If the display of the monitoring target is not usual, the operating state of the corresponding apparatus DV may not be usual. That is, it is monitored whether the operating state of each apparatus DV is usual using the trained model LM. A technique of generating the trained model LM is known; and the detailed description thereof will not be given. An image processor 232 (to be described later) detects the unusual state of the monitoring target, using the trained model LM.

The processor 206 comprises one or more CPUs. The one or more CPUs are an example of one or more processors. The one or more processors and the one or more CPUs are each an example of a computer.

The processor 206 reads the program PG2 from the memory device 205. The processor 206 runs the program PG2 to act as a first acquirer 230A, a first generator 231A, the image processor 232, and the notifier 233. At least one of the first acquirer 230A, the first generator 231A, the image processor 232, and the notifier 233 may be configured with a circuit, such as a DSP, an ASIC, a PLD, or an FPGA.

The inertia measurement device 30 measures (i) an acceleration of the head of the user U in each of three axes representing a three-dimensional space and (ii) an angular velocity of the head of the user U with each of the three axes defined as an axis of rotation. The inertia measurement device 30 is attached to headgear worn by the user U. The inertia measurement device 30 measures the acceleration and the angular velocity each time the user U moves the head. The user U also wears the pair of AR glasses 10A, and the first image capture device 124A is incorporated in the pair of AR glasses 10A. Thus, an amount of movement of the first image capture device 124A is measured using the measurement values of the inertia measurement device 30.

In the embodiment, the inertia measurement device 30 is attached to the headgear worn by the user U. Alternatively, the inertia measurement device 30 may be incorporated in the pair of AR glasses 10A. In this case, the communication device 123 of the pair of AR glasses 10A transmits the measurement values, and the first acquirer 230A acquires the measurement values via the communication device 203. The inertia measurement device 30 is not necessarily attached to the headgear worn by the user U. A place where the inertia measurement device 30 is attached is not limited as long as the place is movable in conjunction with the movement of the head of the user U.

In the embodiment, the inertia measurement device 30 is used for acquiring information about the movement of the head of the user U. Alternatively, a geomagnetic sensor may be used in place of the inertia measurement device 30. The geomagnetic sensor detects the terrestrial magnetism surrounding the earth. The geomagnetic sensor detects values of magnetic force in X, Y, and Z directions. The movement of the head of the user U is estimated based on changes in the detected values.

The first acquirer 230A acquires image information indicating the image PC captured by the first image capture device 124A of the pair of AR glasses 10A. The first acquirer 230A acquires image information indicating the image PC captured by the first image capture device 124A and received by the communication device 203. The foregoing captured image PC shows an object located forward of the user U (i.e., in the direction of sight of the user U). During the work conducted by the user U, the first acquirer 230A successively acquires image information and information about the movement of the head of the user U.

The first generator 231A controls a position in the captured image PC, at which the captured image PC is partially cropped, in accordance with movement information to generate a partial image PS cropped from the captured image PC. The image PC captured during the work conducted by the user U shows the apparatus(es) DV in the rack RA. The first generator 231A generates the partial image PS by cropping a portion showing the monitoring target from the image PC captured by the first image capture device 124A.

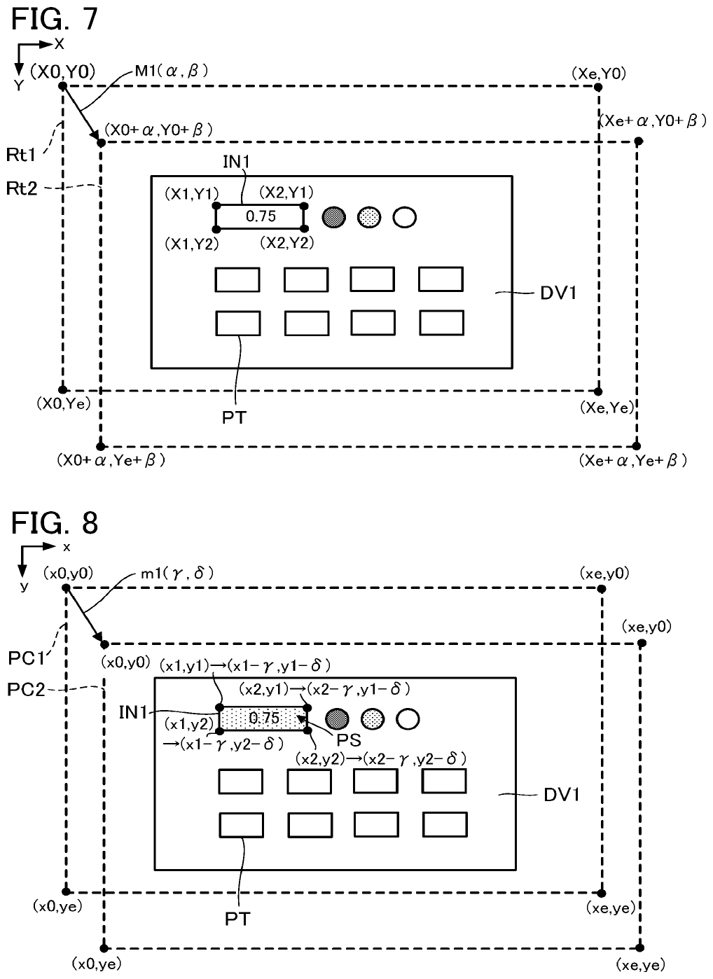

With reference to FIGS. 6 to 8, a more specific description will be given of the generation of the partial image PS by the first generator 231A. FIG. 6 is a front view of an apparatus DV1, which is an example of the apparatuses DV. The apparatus DV1 includes an indicator IN1, a lamp LP1, and a plurality of ports PT. In the apparatus DV1, the indicator IN1 and the lamp LP1 each correspond to a monitoring target. For convenience of the description, the following will focus on the indicator IN1 between the monitoring targets. As an example of FIG. 7, an X-Y coordinate system with an X axis and a Y axis is defined in a real space. It is envisaged that the first image capture device 124A has an imaging range Rt1 at a time T1 corresponding to a reference time, and the imaging range Rt1 is a region surrounded with coordinates (X0, Y0), (Xe, Y0), (Xe, Ye), and (X0, Ye). It is envisaged that the indicator IN1 is in a region surrounded with coordinates (X1, Y1), (X2, Y1), (X2, Y2), and (X1, Y2) in the real space.

FIG. 8 is a diagram illustrating the captured image PC. It is envisaged that a captured image PC1 is an image PC captured in the imaging range Rt1 at the time T1. An x-y coordinate system with an x axis and a y axis is defined on the captured image PC. The captured image PC has coordinates ranging from (x0, y0) to (xe, ye). It is envisaged that in the captured image PC1, the indicator IN1 is in a region surrounded with coordinates (x1, y1), (x2, y1), (x2, y2), and (x1, y2). In the following description, a position of the monitoring target in the captured image PC refers to a set of coordinates that identify a range in which the monitoring target is shown in the captured image PC.

The position of the indicator IN1 in the captured image PC1 may be designated in such a way that the user U traces an outer edge of the indicator IN1 in the captured image PCI displayed on the touch panel 201. Alternatively, the position of the indicator IN1 in the captured image PC1 may be identified through image recognition by the processor 206 using the trained model LM. In the following description, the term “reference image” refers to the captured image PC in which the position of the monitoring target has been designated or identified. The captured image PC1 is defined as the reference image. The first generator 231A generates an image in a hatched region surrounded with coordinates (x1, y1), (x2, y1), (x2, y2), and (x1, y2), as the partial image PS showing the indicator IN1.

It is envisaged that the user U moves with elapse of time from T1 to T2 (the time T2 is later than the time T1), resulting in the positional change of the first image capture device 124A. It is envisaged that the amount of movement of the first image capture device 124A from the time T1 to the time T2 is calculated as M1(α, β) from X-Y coordinate values. The values of α and β are each a positive number. The amount of movement M1 is calculatable based on measurement values of the inertia measurement device 30. In this case, an imaging range Rt2 at the time T2 corresponds to a region surrounded with coordinates (X0+α, Y0+β), (Xe+α, Y0+β), (Xe+α, Ye+β), and (X0+α, Ye+β). The coordinates of the indicator IN1 on the real space are equal to those at the time T1.

As illustrated in FIG. 8, it is envisaged that a captured image PC2 is an image PC captured in the imaging range Rt2 at the time T2. The captured image PC2 also has coordinates ranging from (x0, y0) to (xe, ye) as in the captured image PC1. Since the position of the imaging range Rt on the real space is changed with the lapse of time from T1 to T2, the coordinates of the indicator IN1 in the captured image PC2 differ from the coordinates of the indicator IN1 in the captured image PC1. Specifically, using m1(γ, δ) obtained by converting the amount of movement M1(α, β) of the first image capture device 124A into an amount of movement on the captured image PC, the indicator IN1 is in a region surrounded with coordinates (x1-γ, y1-δ), (x2-γ, y1-δ), (x2-γ, y2-δ), and (x1-γ, y2-δ) in the captured image PC2. The values of γ and δ are each a positive number. That is, the position of the indicator IN1 in the captured image PC2 is changed by −m1 as compared with that in the captured image PC1 corresponding to the reference image. In this case, the first generator 231A generates an image in a region surrounded with coordinates (x1-γ, y1-δ), (x2-γ, y1-δ), (x2-γ, y2-δ), and (x1-γ, y2-δ), as the partial image PS showing the indicator IN1.

Thereafter, the first generator 231A calculates an amount of movement Mx of the first image capture device 124A from a time Tx to a time Tx+1, based on the measurement values of the inertia measurement device 30 (x: an integer that is equal to or greater than 1). The first generator 231A converts the amount of movement Mx of the first image capture device 124A into an amount of movement mx on the captured image PC. The first generator 231A generates a partial image PS on the assumption that a position shifted by an amount of movement (−mx) from a position (coordinates) of the indicator IN1 on a captured image PCx at the time Tx is a position of the indicator IN1 on a captured image PCx+1 at the time Tx+1.

As described above, the first generator 231A identifies the position of the monitoring target (e.g., the indicator IN1) in the captured image PC at each time, using the measurement values of the inertia measurement device 30. In other words, the first generator 231A changes the coordinates of the region regarded as the partial image PS in the captured image PC, based on the measurement values of the inertia measurement device 30. It is possible to reduce a processing load to be imposed on the processor 206 and to increase a processing speed of the processor 206, as compared with a case in which the position of the monitoring target in the captured image PC is tracked using, for example, an image processing technique such as background subtraction.

The foregoing description has been given using the two-dimensional X-Y coordinate system for convenience. Alternatively, the first generator 231A may generate a partial image PS in consideration of an amount of movement of the user U in three-dimensional coordinates.

The image processor 232 performs image processing on the partial image PS cropped by the first generator 231A. In the embodiment, the term “image processing” refers to processing of monitoring a state of a monitoring target, using AI. The image processor 232 determines whether the state of the monitoring target shown in the partial image PS generated by the first generator 231A is usual, using the trained model LM stored in the memory device 205.

An image to be subjected to processing by the image processor 232 is not the image PC captured by the first image capture device 124A, but is the partial image PS generated by the first generator 231A. In the embodiment, an image to be subjected to processing is smaller in size than the image PC captured by the first image capture device 124A. This configuration reduces the processing load to be imposed on the processor 206 and increases the processing speed of the processor 206.

The image processor 232 may monitor a target by another method in addition to the use of AI. For example, the image processor 232 may monitor a target by a method of reading a level of the indicator IN in the partial image PS with an optical character reader (OCR) and determining whether the read value falls within a predetermined threshold range. Even in this case, an image to be subjected to processing is smaller in size than the captured image PC. This configuration reduces the processing load to be imposed on the processor 206 and increases the processing speed of the processor 206.

The notifier 233 notifies the user U that the monitoring target is in the unusual state, which is determined by the image processor 232. For example, the notifier 233 generates a control signal for displaying a warning message on the projector 121 of the pair of AR glasses 10A (i.e., an image display control signal), and transmits the image display control signal to the pair of AR glasses 10A via the communication device 203. The notifier 233 generates a control signal for causing, for example, each sound output device 122 of the pair of AR glasses 10A to output a warning sound, that is, a sound output control signal, and transmits the sound output control signal to the pair of AR glasses 10A via the communication device 203. With regard to a visible notification such as display of a warning message and an audible notification such as output of a warning sound, both of the notifications or one of the notifications may be provided.

The user U, who has received the display of the warning message or the output of the warning sound, is able to notice that the contents or procedures of the user's work are possibly wrong. In this case, the user U is able to check the contents or procedures of the work, thereby promptly addressing a mistake in the work. This configuration thus improves the efficiency and accuracy of the work.

### A-4. Procedures for Processor 206

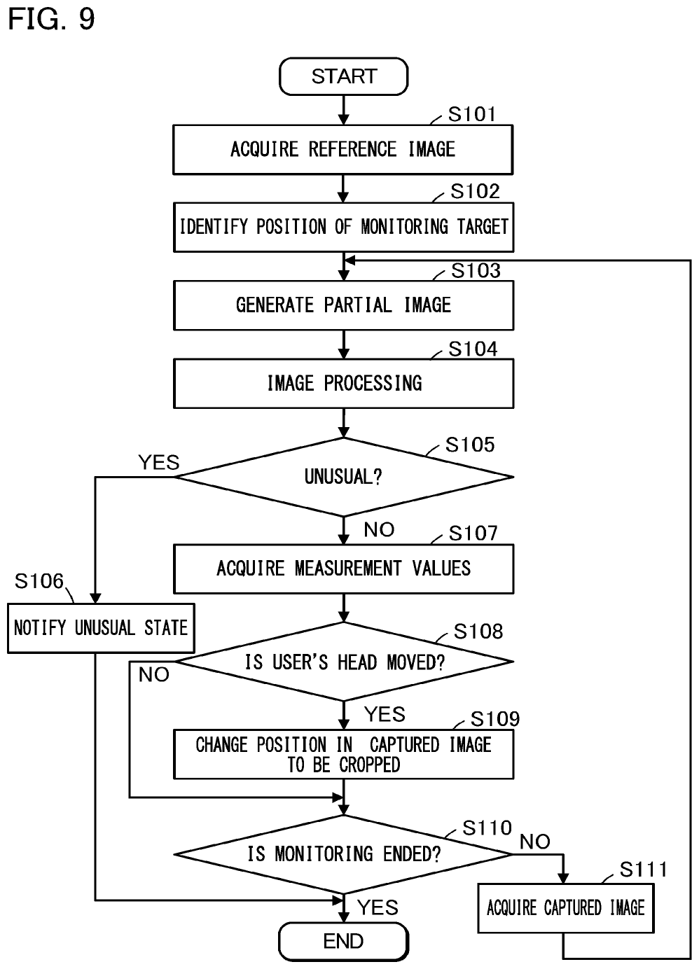

FIG. 9 is a flowchart illustrating procedures for the processor 206. The processor 206 acts as the first acquirer 230A to acquire a reference image, that is, an image PC captured by the first image capture device 124A at a reference time (step S101). The processor 206 identifies a position of a monitoring target within the reference image (step S102). As described above, the position of the monitoring target within the reference image may be designated by the user U or may be identified by the processor 206.

The processor 206 acts as the first generator 231A to generate a partial image PS by cropping a range covering the monitoring target, from the reference image (step S103). Next, the processor 206 acts as the image processor 232 to perform image processing on the partial image PS generated in step S103 (step S104). More specifically, the processor 206 applies the trained model LM to the partial image PS, and determines whether the state of the monitoring target is unusual.

When the state of the monitoring target is unusual (step S105: YES), the processor 206 acts as the notifier 233 to generate a control signal and transmit the control signal to the pair of AR glasses 10A so as to cause the pair of AR glasses 10A to output a warning message or a warning sound. In other words, the processor 206 acts as the notifier 233 to notify the user U that the monitoring target is in an unusual state (step S106). The processor 206 then ends the processing of this flowchart.

When the state of the monitoring target is usual (step S105: NO), the processor 206 acts as the first acquirer 230A to acquire measurement values of the inertia measurement device 30 (step S107). The processor 206 acts as the first generator 231A to determine whether the head of the user U has been moved, based on the measurement values of the inertia measurement device 30 (step S108).

When the head of the user U has been moved (step S108: YES), the processor 206 acts as the first generator 231A to change a position in the captured image PC to be cropped from the captured image PC as the partial image PS (step S109). When the head of the user U is not moved (step S108: NO), the processor 206 causes the processing to proceed to step S110.

Unless an end of monitoring the target (step S110: NO), the processor 206 acts as the first acquirer 230A to acquire the image PC captured by the first image capture device 124A (step S111). The processor 206 then causes the processing to return to step S103, and executes the processing from step S103 again. For example, the end of monitoring the target refers to a case in which the user U moves away from the target after completion of the work. At the end of monitoring the target (step S110: YES), the processor 206 ends the processing in this flowchart.

A-5. Summary of first embodiment

As described above, according to the first embodiment, in the mobile apparatus 20A, the first generator 231A crops a part of a captured image PC as a partial image PS, and the image processor 232 performs image processing on the partial image PS. As a result, according to the first embodiment, the processing load to be imposed on the processor 206 is reduced as compared with a case in which a captured image is subjected to image processing as a whole.

According to the first embodiment, the partial image PS is generated by cropping a region showing an object previously designated, from the captured image PC in accordance with the movement of the head of the user U. Therefore, according to the first embodiment, the processing load to be imposed on the processor 206 is reduced as compared with a case in which a designated portion in an image is tracked by image analysis.

According to the first embodiment, the first acquirer 230A acquires information about the movement of the head of the user U, using the inertia measurement device 30. As a result, according to the first embodiment, the movement of the head of the user U, that is, a change in direction of capturing an image by the first image capture device 124A is detected with good accuracy. Furthermore, the processing load to be imposed on the processor 206 is reduced as compared with a case in which the movement of the head of the user U is tracked by image analysis.

According to the first embodiment, a state of a target is monitored during work conducted by the user U. As a result, the user U is able to reduce a degree of attention to be paid to the monitoring target. This configuration thus allows the user U to concentrate well on the work and improves the work efficiency.

### B. Second Embodiment

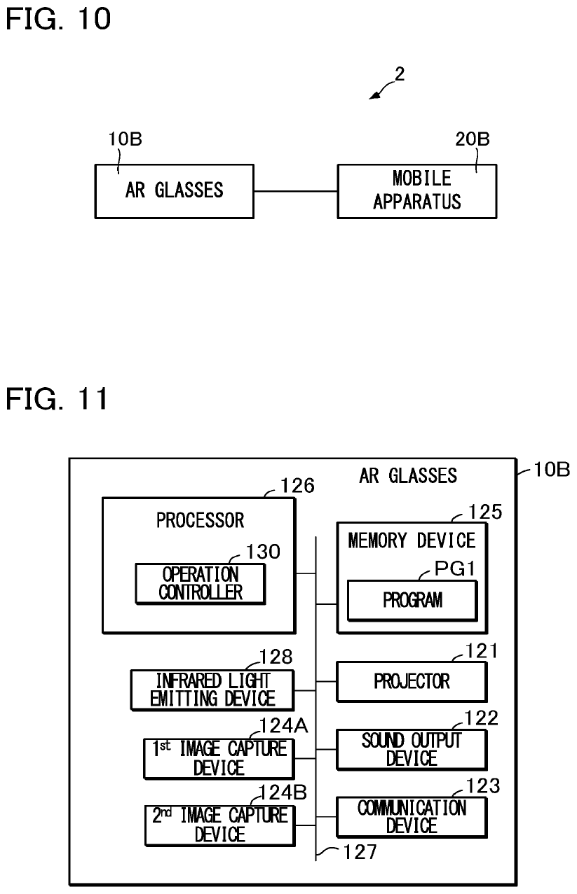

With reference to FIGS. 10 to 18, next, a description will be given of a configuration of an information processing system 2 including an information processing apparatus according to a second embodiment of this invention. In the following, the same constituent elements as those described in the first embodiment are denoted with the same reference signs for simplification of the description. The functional description thereof will not be given. A description will mainly be given of a difference between the second embodiment and the first embodiment for simplification of description.

### B-1. System Configuration of Information Processing System 2

FIG. 10 is a block diagram illustrating a configuration of the information processing system 2 according to the second embodiment. The information processing system 2 includes a pair of AR glasses 10B mountable to the head of the user U, and a mobile apparatus 20B which the user U carries.

### B-2. Pair of AR Glasses 10B

FIG. 11 is a block diagram illustrating a configuration of the pair of AR glasses 10B. The pair of AR glasses 10B further includes an infrared light emitting device 128 in addition to the configuration of the pair of AR glasses 10A illustrated in FIG. 4. The infrared light emitting device 128 irradiates the eyes (e.g., the corneas) of the user U wearing the pair of AR glasses 10B, with infrared light. For example, the infrared light emitting device 128 includes irradiators disposed on surfaces of rims 106 and 107, the surfaces facing the eyes of the user U, respectively.

The pair of AR glasses 10B further includes a second image capture device 124B in addition to a first image capture device 124A. As described above, the first image capture device 124A includes an imaging lens LEN on a nose bridge 103 of the pair of AR glasses 10B, and captures an image of an object located forward of the user U (i.e., in the direction of sight of the user U). In the second embodiment, the term “captured image PC” refers to an image captured by the first image capture device 124A as in the first embodiment.

For example, the second image capture device 124B includes imaging lenses LEN (not illustrated) disposed on the surfaces of the rims 106 and 107, the surfaces facing the eyes of the user U, respectively, with the user U wearing the pair of AR glasses 10B. The second image capture device 124B captures an image showing the eyes of the user U. As described above, the infrared light emitting device 128 irradiates the eyes of the user U with infrared light. The image captured by the second image capture device 124B shows the eyes of the user U irradiated with infrared light. In the embodiment, the term “eye tracking image PE” refers to an image captured by the second image capture device 124B.

### B-3. Mobile Apparatus 20B

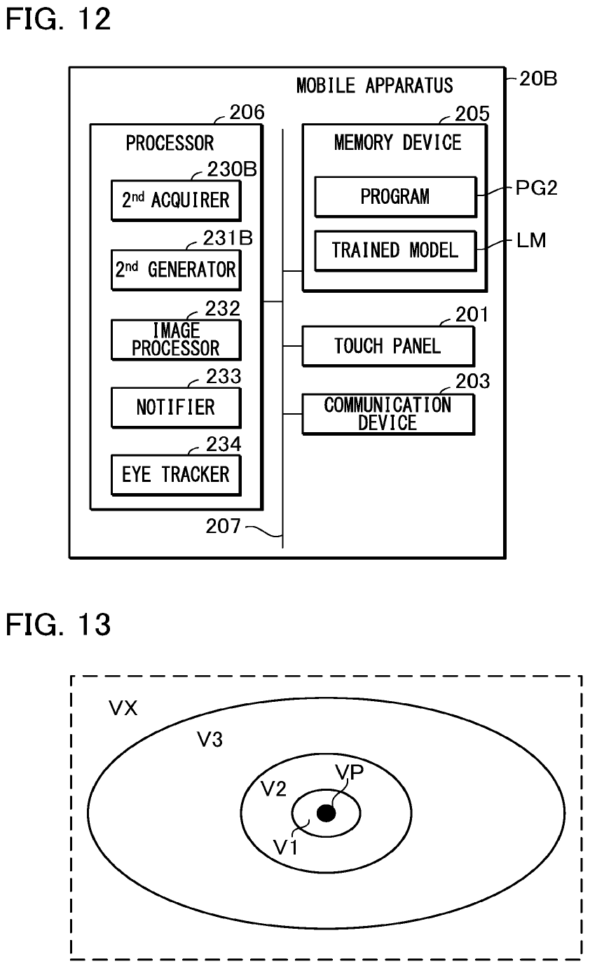

FIG. 12 is a block diagram illustrating a configuration of the mobile apparatus 20B. The mobile apparatus 20B includes a processor 206 that further acts as an eye tracker 234 in addition to the functions illustrated in FIG. 5. The eye tracker 234 tracks movement of the eyes of the user U, and calculates eye information about the movement of the eyes of the user U. In the embodiment, the eye tracker 234 tracks the movement of the eyes of the user U, by a corneal reflection method. As described above, a reflective spot of light is formed on each of the corneas of the eyes of the user U by the emission of infrared light from the infrared light emitting device 128 of the pair of AR glasses 10B. The eye tracker 234 identifies the pupils and the reflective spots of light on the corneas, from the eye tracking image PE captured by the second image capture device 124B. The eye tracker 234 then calculates the direction of the eyeballs of the user U, that is, a line of sight of the user U, based on the reflective spots of light and other geometric features. The eye tracker 234 continuously calculates the line of sight of the user U, and calculates eye information about the movement of the eyes of the user U.

The processor 206 acts as a second acquirer 230B in place of the first acquirer 230A illustrated in FIG. 5. The processor 206 also acts as a second generator 231B in place of the first generator 231A illustrated in FIG. 5.

The second acquirer 230B acquires movement information about the movement of the user U wearing the pair of AR glasses 10A. In the second embodiment, the second acquirer 230B acquires, as the movement information, eye information about the movement of the eyes of the user U. The second acquirer 230B acquires eye information calculated by the eye tracker 234. The second acquirer 230B successively acquires eye information during the work conducted by the user U.

The second acquirer 230B acquires image information on an image PC captured by the first image capture device 124A of the pair of AR glasses 10B. The second acquirer 230B acquires image information indicating an image PC captured by the first image capture device 124A and received by a communication device 203. As described above, the captured image PC captured by the first image capture device 124A shows an object and the like located forward of the user U (i.e., in the direction of sight of the user U). The second acquirer 230B successively acquires image information during the work conducted by the user U.

The second acquirer 230B acquires image information on an eye tracking image PE captured by the second image capture device 124B of the pair of AR glasses 10B. The eye tracking image PE acquired by the second acquirer 230B is used for eye tracking to be performed by the eye tracker 234.

The second generator 231B controls a position in the captured image PC, at which the captured image PC is partially cropped, in accordance with the movement information to generate a partial image PS cropped from the captured image PC. As described above, the image PC captured during the work conducted by the user U shows the one or more apparatuses DV in the rack RA. The second generator 231B generates the partial image PS by cropping a region out of a region visually recognized by the user U, from the image PC captured by the first image capture device 124A, based on the eye information.

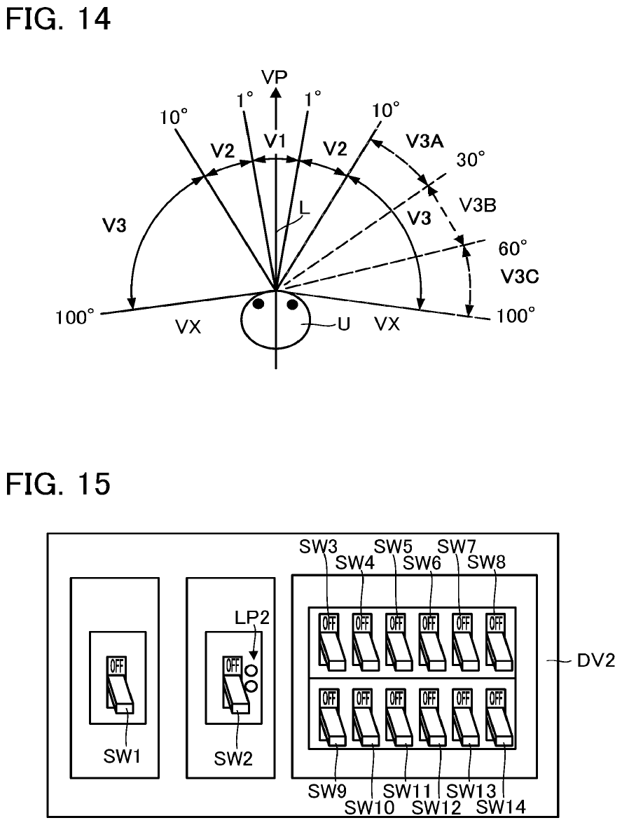

With reference to FIGS. 13 to 17, a more specific description will be given of the generation of the partial image PS by the second generator 231B. FIGS. 13 and 14 are diagrams each schematically illustrating a visual field range of the user U. More specifically, FIG. 13 illustrates the visual field range in the direction of sight of the user U. FIG. 14 illustrates the visual field range of the user U seen from above.

The visual field of the user U is mainly divided into a center visual field V1, an effective visual field V2, and a peripheral visual field V3. In addition, an out-of-sight field VX is present outside the peripheral visual field V3.

The center visual field V1 is a region in which the user U maximumly exhibits discrimination ability for visual information. For convenience, a center point of the center visual field V1 is defined as a viewpoint VP. The direction of sight L of the user U corresponds to a direction from the user U to the viewpoint VP. In a horizontal plane that is parallel with a clearance between the eyes of the user U, the center visual field V1 is within a range of approximately 1° relative to the direction of sight L. The term “visual field angle” refers to an angle of an outer edge of each visual field range relative to the direction of sight L. For example, the visual field angle of the center visual field V1 is approximately 1°.

The discrimination ability of the user U in the effective visual field V2 is lower than that in the center visual field V1. In the effective visual field V2, however, the user U is able to recognize, as visual information, simple characters such as numbers. In other words, the user U is able to recognize text information in a range nearer to the viewpoint VP than to the effective visual field V2. In the horizontal plane, the effective visual field V2 is within a range from approximately 1° to approximately 10° relative to the direction of sight L. In other words, a visual field angle of the effective visual field V2 is approximately 10°.

In the peripheral visual field V3, a minimum requirement for the discrimination ability of the user U is to identify the presence of an object. The peripheral visual field V3 is separated into two or more ranges in accordance with the level of the discrimination ability of the user U. Specifically, the peripheral visual field V3 is separated into the following: (i) a first peripheral visual field V3A in which the user U is able to recognize a shape (a symbol), (ii) a second peripheral visual field V3B in which the user U is able to discriminate a changing color, and (iii) a third peripheral visual field V3C corresponding to a visual field to an extent that the user U recognizes the presence of visual information, that is, an auxiliary visual field. In the horizontal plane, the first peripheral visual field V3A is within a range from approximately 10° to approximately 30° relative to the direction of sight L. In other words, a visual field angle of the first peripheral visual field V3A is approximately 30°. In the horizontal plane, the second peripheral visual field V3B is within a range from approximately 30° to approximately 60° relative to the direction of sight L. In other words, a visual field angle of the second peripheral visual field V3B is approximately 60°. In the horizontal plane, the third peripheral visual field V3C is within a range from approximately 60° to approximately 100° relative to the direction of sight L. In other words, a visual field angle of the third peripheral visual field V3C is approximately 100°.

The out-of-sight field VX corresponds to a region in which the user U fails to notice visual information, that is, an invisible region.

As described above, the discrimination ability of the user U is higher as the visual information is nearer to the center visual field V1 and is lower as the visual information is farther from the center visual field V1. Te area of each visual field range varies between individuals. In addition, FIGS. 13 and 14 each schematically illustrate the positional relationship between the visual field ranges. An area ratio between the visual field ranges, an angle of each visual field range relative to the direction of sight L, and others are different from actual ones.

FIG. 15 is a front view of an apparatus DV2, which is an example of the apparatuses DV. The apparatus DV2 includes switches SW1 to SW14, and a lamp LP2. Each of the switches SW1 to SW14 may be turned on or off. In FIG. 12, all the switches SW1 to SW14 are turned off. The lamp LP2 may be turned on or off.

In the first embodiment, when the switches SW1 and SW2 among the switches SW1 to SW14 are each designated as a monitoring target, the first generator 231A generates a partial image PS by identifying the positions of the switches SW1 and SW2 in a captured image PC, based on the movement of the head of the user U. That is, in the first embodiment, a monitoring target is fixed.

In contrast to the first embodiment, in the second embodiment, a monitoring target is not fixed, but is changed based on the visual field ranges of the user U. More specifically, the second generator 231B generates a partial image PS by cropping a region out of a region in which the user U is able to recognize predetermined information, from a captured image PC, based on eye information.

As described above, the user U does not exhibit equal discrimination ability in all the visually recognizable regions. In a region farther from the viewpoint VP, the discrimination ability is lower. In the second embodiment, therefore, the second generator 231B crops, as a partial image PS, a region far from the viewpoint VP of the user U, and an image processor 232 performs image processing on the partial image PS, using AI. In contrast, in a region nearer to the viewpoint VP of the user U, the user U exhibits higher discrimination ability. In a region nearer to the viewpoint VP, therefore, the image processor 232 does not perform image processing, but the user U performs state discrimination.

In the embodiment, the second generator 231B determines a range to be cropped as a partial image PS with the foregoing visual field ranges for reference. For example, the second generator 231B crops, as a partial image PS, a portion of a captured image PC in the peripheral visual field V3 and out-of-sight field VX. In this case, the peripheral visual field V3 and the out-of-sight field VX each correspond to the region out of the region in which the user U is able to recognize the predetermined information. The predetermined information is text information. In general, the out-of-sight field VX is not shown in the captured image PC depending on the angle of view of the first image capture device 124A.

At this time, the second generator 231B identifies the position of the viewpoint VP of the user U, based on the eye information, and crops a portion separated from the viewpoint VP by a predetermined distance or more, as the partial image PS. For example, the predetermined distance is geometrically calculatable from the foregoing visual field angles. Specifically, when the region in the peripheral visual field V3 and out-of-sight field VX is cropped as the partial image PS, a distance from the viewpoint VP to the peripheral visual field V3 is calculated by computation of D×tanθ. Where D is a distance between an imaging target such as each apparatus DV and the user U (i.e., the first image capture device 124A). θ is the visual field angle of the effective visual field V2 adjacent to the peripheral visual field V3. The predetermined distance may be changed in accordance with the visual characteristics of the user U which are measured in advance, for example.

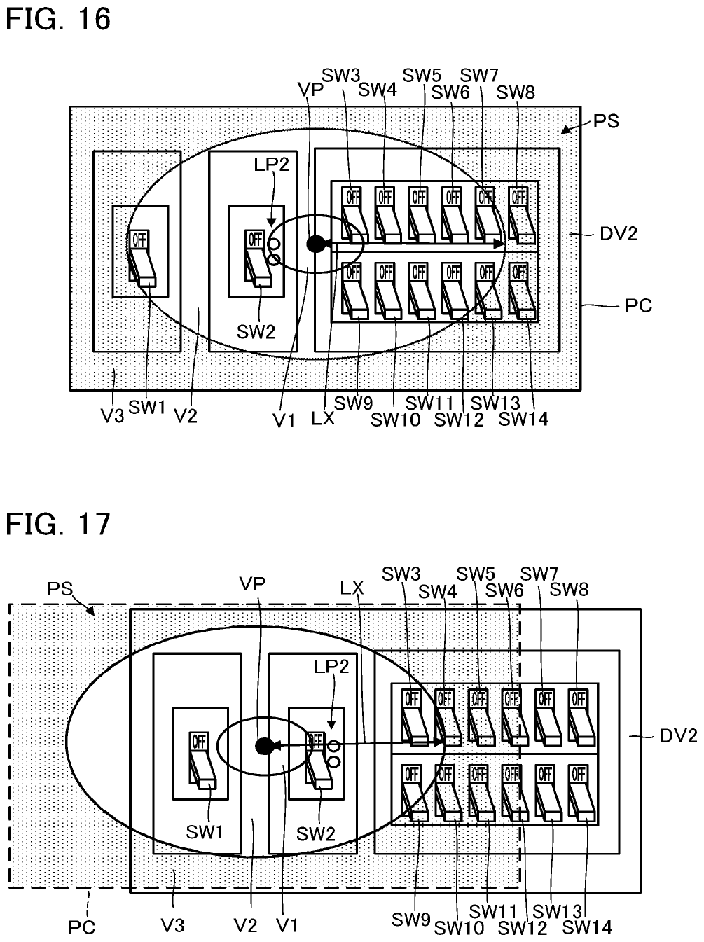

FIGS. 16 and 17 are diagrams each illustrating an example of a positional relationship between the captured image PC and the visual field ranges of the user U. As illustrated in FIG. 16, when the viewpoint VP of the user U is located at the center of the apparatus DV2, a range that extends from the viewpoint VP horizontally by a predetermined distance LX is located within the center visual field V1 and the effective visual field V2. Specifically, the center visual field V1 and effective visual field V2 cover the lamp LP2, the switches SW1 to SW7, and the switches SW9 to SW13. In this case, the second generator 231B crops, as the partial image PS, a range excluding the center visual field V1 and the effective visual field V2 (i.e., a portion showing the hatched switches SW8 and SW14) in the captured image PC. The objects shown in the partial image PS thus cropped are targets to be subjected to processing by the image processor 232.

As illustrated in FIG. 17, when the viewpoint VP of the user U is located on the left side of the apparatus DV2, a range covering the lamp LP2 and switches SW1 to SW3 and SW9 is located within the center visual field V1 and the effective visual field V2. In this case, the second generator 231B crops, as the partial image PS, a range excluding the center visual field V1 and the effective visual field V2 (i.e., a portion showing the hatched switches SW4 to SW6 and SW10 to SW12) in the captured image PC.

The image processor 232 performs image processing on the partial image PS cropped by the second generator 231B, in the same manner as that described in the first embodiment. The image processing refers to processing of monitoring a state of a target, using AI. The image processor 232 determines whether the state of each monitoring target shown in the partial image PS generated by the second generator 231B is usual, using a trained model LM stored in a memory device 205.

In the second embodiment, an image to be subjected to processing by the image processor 232 is not the image PC captured by the first image capture device 124A, but the partial image PS generated by the second generator 231B. In the embodiment, an image to be subjected to processing is smaller in size than the captured image PC captured by the first image capture device 124A. This configuration reduces a processing load to be imposed on the processor 206 and increases a processing speed of the processor 206.

### B-4. Procedures for Processor 206

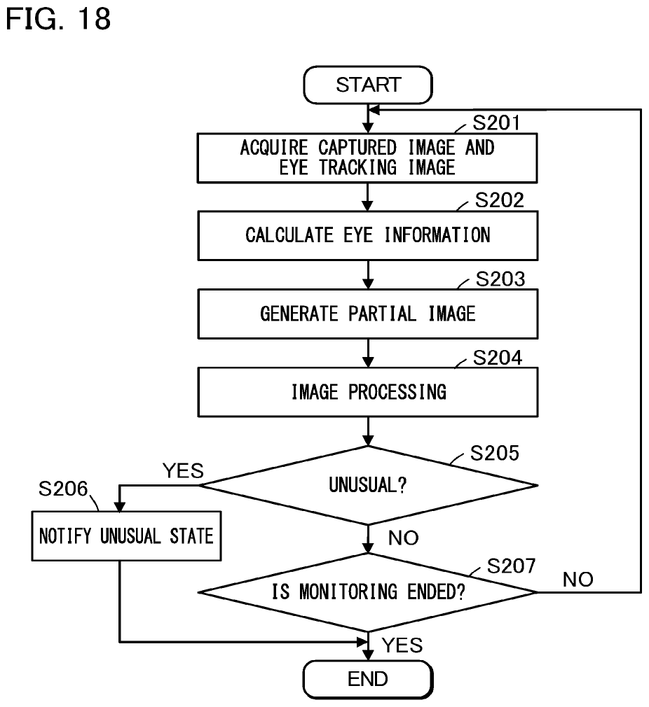

FIG. 18 is a flowchart illustrating procedures for the processor 206. The processor 206 acts as the second acquirer 230B to acquire an image PC captured by the first image capture device 124A and an eye tracking image PE captured by the second image capture device 124B (step S201). The processor 206 acts as the eye tracker 234 to calculate eye information about the movement of the eyes of the user U, based on the eye tracking image PE (step S202).

The processor 206 acts as the second generator 231B to generate, as a partial image PS, a portion of the captured image PC excluding a portion located in the center visual field V1 and effective visual field V2 of the user U (step S203). The processor 206 acts as the image processor 232 to perform image processing on the partial image PS generated in step S203 (step S204). More specifically, the processor 206 applies the trained model LM to the partial image PS, and determines whether a state of a monitoring target in the partial image PS is unusual.

When the state of the monitoring target is unusual (step S205: YES), the processor 206 acts as a notifier 233 to generate a control signal and transmit the control signal to the pair of AR glasses 10A so as to cause the pair of AR glasses 10A to output a warning message or a warning sound. In other words, the processor 206 acts as a notifier 233 to notify the user U that the monitoring target is in an unusual state (step S206). The processor 206 then ends the processing of this flowchart.

When the state of the target is usual (step S205: NO), the processor 206 causes the processing to return to step S201, and executes the processing from step S201 again unless monitoring of the monitoring target (step S207: NO) ends. The end of monitoring refers to, for example, a case in which the user U moves away from the monitoring target after completion of the work. At the end of monitoring the target (step S207: YES), the processor 206 ends the processing of this flowchart.

### B-5. Summary of Second Embodiment

According to the second embodiment, the second generator 231B generates the partial image PS by cropping the region out of the region visually recognized by the user U, from the captured image PC. For this reason, the region not visually recognized by the user U is subjected to processing by the image processor 232. This configuration thus reduces a burden on the user U.

According to the second embodiment, the second generator 231B crops, as the partial image PS, the portion separated from the viewpoint VP of the user U by the predetermined distance or more. For this reason, the region outside of the region visually recognized by the user U is cropped by simple processing.

### C: Modifications

The following will describe various modifications of the foregoing embodiments. Two or more modifications optionally selected from among the following modifications may be combined as appropriate as long as they do not conflict.

### C1: First Modification

In the second embodiment, the partial image PS is generated by cropping the region out of the region visually recognized by the user U. At this time, the contents of the image processing to be performed by the image processor 232 may be changed so that the partial image PS is divided into a plurality of regions, based on a distance from the viewpoint VP.

In the examples of FIGS. 16 and 17, the portion of the captured image PC in the peripheral visual field V3 and out-of-sight field VX is cropped as the partial image PS. At this time, the peripheral visual field V3 includes the first peripheral visual field V3A and the second peripheral visual field V3B. The image processor 232 may change the contents of image processing between the portion in the first peripheral visual field V3A and the portion in the second peripheral visual field V3B. Specifically, image processing with relatively lower load is performed on the portion in the first peripheral visual field V3A relatively nearer to the center visual field V1. This is because the first peripheral visual field V3A is a region that is located near the effective visual field V2 and is recognizable by the user U to a certain degree. In contrast, image processing with relative higher load is performed on the portion in the second peripheral visual field V3B in order to improve monitoring. This is because the second peripheral visual field V3B is a region in which the discrimination ability of the user U is relatively low.

For example, when the lamp LP is regarded as a monitoring target, the processor 206 performs identification of the color of the lamp in the ON state under a higher load, rather than monitoring as to whether the lamp is turned ON or OFF. For this reason, the image processor 232 monitors whether the lamp is turned ON or OFF as to the portion in the first peripheral visual field V3A. In contrast, the image processor 232 monitors whether the lamp is turned ON or OFF and identifies the color of the lamp in the ON state as to the portion in the second peripheral visual field V3B.

In other words, the second generator 231B identifies the position of the viewpoint VP of the user U, based on the eye information, and crops the partial image PS in the first peripheral visual field V3A and the partial image PS in the second peripheral visual field V3B, based on the distance from the position of the viewpoint VP. A degree of gazing at the partial image in the first peripheral visual field V3A by the user U is different from a degree of gazing at the partial image in the second peripheral visual field V3B by the user U. A difference in degree of gazing at the partial image by the user U means a difference in discrimination ability of the user U. The discrimination ability of the user U for the partial image in the first peripheral visual field V3A differs from the discrimination ability of the user U for the partial image in the second peripheral visual field V3B.

The image processing to be performed by the image processor 232 on the partial image PS in the first peripheral visual field V3A differs from that to be performed by the image processor 232 on the partial image PS in the second peripheral visual field V3B. The partial image PS in the first peripheral visual field V3A is an example of a first partial image. The partial image PS in the second peripheral visual field V3B is an example of a second partial image.

According to the first modification, the partial image PS is divided into a plurality of portions, based on the distance from the viewpoint, and the divided portions are subjected to different kinds of image processing, respectively. This configuration thus improves the usability of image processing and achieves more effective use of the resources of the processor 206.

### C2: Second Modification

In the first embodiment, the pair of AR glasses 10A and the mobile apparatus 20A are provided separately. Furthermore, the pair of AR glasses 10A and the mobile apparatus 20B are provided separately. Alternatively, the pair of AR glasses 10A may have the function of the mobile apparatus 20A, and the pair of AR glasses 10A may have the function of the mobile apparatus 20B. In other words, the processor 126 of the pair of AR glasses 10A may function as the first acquirer 230A, the first generator 231A, the image processor 232, and the notifier 233. Moreover, the processor 126 of the pair of AR glasses 10B may function as the second acquirer 230B, the second generator 231B, the image processor 232, the notifier 233, and the eye tracker 234.

According to the second modification, the user U is able to monitor a target during the work without using the mobile apparatuses 20A and 20B.

### C3: Third Modification

In the first embodiment, the mobile apparatus 20A performs image processing on a partial image PS. Furthermore, the mobile apparatus 20B performs image processing on a partial image PS. Alternatively, an image processing server connected to the mobile apparatus 20A or 20B via a network may perform image processing on a partial image PS. In this case, the mobile apparatus 20A or mobile apparatus 20B transmits, to the image processing server, a partial image PS generated by the first generator 231A or second generator 231B. The image processing server performs image processing on the partial image PS. When detecting an unusual state of a monitoring target, the image processing server transmits a control signal to the mobile apparatus 20A or 20B so that the mobile apparatus 20A or 20B provides a notification to the user U through the pair of AR glasses 10A or 10B.

According to the third modification, the user U is able to monitor a target during the work even in a case in which the mobile apparatuses 20A and 20B each have no program for implementing the image processor 232 or each have no processability to execute a program for implementing the image processor 232. According to the third modification, an image to be transmitted from the mobile apparatus 20A or 20B to the image processing server is not a captured image PC, but a partial image PS obtained by partially cropping the captured image PC. This configuration therefore reduces a communication load between the mobile apparatus 20A or 20B and the image processing server and an image processing load to be imposed on the image processing server, and increases a processing speed of the entire system.

### C4: Fourth Modification

In the first embodiment, the pair of AR glasses 10A includes the first image capture device 124A. Furthermore, the pair of AR glasses 10B includes the first image capture device 124A. Alternatively, for example, an image capture device corresponding to the first image capture device 124A may be simply mounted to the head of the user U. An apparatus including the first image capture device 124A is not limited to a display device such as the pair of AR glasses 10A or 10B. Such an apparatus may be an audio output device configured to output audio.

### C5: Fifth Modification

In the first embodiment, a result of image processing performed on a part of an image captured by the first image capture device 124A of the pair of AR glasses 10A, that is, a partial image is fed back (notified) to the user U through the pair of AR glasses 10A. Furthermore, a result of image processing performed on a part of an image captured by the first image capture device 124A of the pair of AR glasses 10B, that is, a partial image is fed back (notified) to the user U through the pair of AR glasses 10B.

Alternatively, a result of image processing may be fed back through an apparatus different from the pair of AR glasses 10A and the pair of AR glasses 10B. A result of image processing may be fed back to the mobile apparatus 20A or 20B or another information processing apparatus which the user U carries. The result of image processing may be fed back to a person different from the user U (e.g., a director of the work conducted by the user U). Alternatively, the result of image processing may be fed back to an information processing apparatus (e.g., a work management server) which the user U does not carry.

### D: Other Matters

(1) These functions illustrated in FIGS. 3, 4, 11 and 12 are implemented by an optional combination of hardware, software, or both. The means for realizing functions is not particularly limited. Each function may be implemented by one device physically combined or logically combined. Each function may be implemented by devices in which two or more devices physically shared or logically separated are directly or indirectly (e.g., wired or wirelessly) connected. These functional blocks (components) are implemented by an optional combination of hardware, software or both.

(2) The term “apparatus” as used herein may be replaced with another term such as circuit, device, or unit, in this specification.

(3) In the first and second embodiments, and the first to third modifications, the memory devices 125 and 205 may comprise at least one of the following: an optical disk, such as a Compact Disc ROM (CD-ROM), a hard disk drive, a flexible disk, a magneto-optical disk (e.g., a Compact Disc, a Digital Versatile Disc, a Blu-ray (registered trademark), a smart card, a flash memory (e.g., a card, a stick, a key drive), a floppy (registered trademark) disc, and a magnetic strip. The program may be transmitted from a network via a telecommunication line.

(4) The first and second embodiments, and the first to third modifications may be applied to at least one of the following: Long Term Evolution (LTE), LTA-Advanced (LTE-A), SUPER 3G, IMT-Advanced, 4th generation mobile communication system (4G), 5th generation mobile communication system (5G), 6th generation mobile communication system (6G), xth generation mobile communication system (xG) (x is an integer or decimal), Future Radio Access (FRA), New Radio (NR), New radio access (NX), Future generation radio access (FX), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, UWB (Ultra WideBand), Bluetooth (registered trademark), (Ultra WideBand), Bluetooth (registered trademark), and other appropriate systems, Bluetooth (registered trademark), other appropriate systems, and next generation systems that are extended, modified, generated or defined on the basis of these systems. These systems may be combined (e.g., a combination of 5G and at least one of LTE and LTE-A).

(5) The order of the processing procedures, sequence, flowchart, and the like in the first and second embodiments, and the first to third modifications may be changed as long as there is no conflict. For example, for the methods described herein, elements of various steps are presented in an example order and are not limited to the particular order presented.

(6) In the first and second embodiments, and the first to third modifications, input and/or output information, etc., may be stored in a specific location (e.g., memory) or may be managed by use of a management table. The information, etc., that is input and/or output may be overwritten, updated, or appended. The information, etc., that is output may be deleted. The information, etc., that is input may be transmitted to other devices.

(7) In the first and second embodiments, and the first to third modifications, determination may be made by values that can be represented by one bit (0 or 1), may be made in Boolean values (true or false), or may be made by comparing numerical values (for example, comparison with a predetermined value).

(8) In the first and second embodiments, and the first to third modifications, programs, whether referred to as software, firmware, middleware, microcode, hardware description language, or by any other name, are instructions, instruction sets, code, code segments, or program code. It should be interpreted broadly to mean programs, subprograms, software modules, applications, software applications, software packages, routines, subroutines, objects, executable files, execution threads, procedures, functions, etc. Software, instructions and so forth may be transmitted and received via communication media. For example, when software is transmitted from a website, a server, or other remote sources, by using wired technologies such as coaxial cables, optical fiber cables, twisted-pair cables, and digital subscriber lines (DSL), and/or wireless technologies such as infrared radiation, radio and microwaves, etc., these wired technologies and/or wireless technologies are also included in the definition of communication media.

(9) In the first and second embodiments, and the first to third modifications, information and the like may be presented by use of various techniques. For example, data and instructions may be presented by freely selected combination of voltages, currents, electromagnetic waves, magnetic fields or magnetic particles, light fields or photons. Terms described in this specification and terms necessary for understanding this specification may be replaced with the same terms or other similar terms.

(10) In the first and second embodiments, and the first to third modifications, the terms “system” and “network” are used interchangeably.

(11) In the first and second embodiments, and the first to third modifications, the mobile apparatus 20A or 20B may be a mobile station. A mobile station (mobile device) may be referred to, by one skilled in the art as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, a “access terminal”, a “mobile terminal”, a “wireless terminal”, a “remote terminal”, a “handset”, a “user agent”, a “mobile client”, a “client”, or some other suitable terms.

(12) A mobile station may be referred to as a transmitter, receiver, or communicator. The mobile station may be a device mounted to a mobile object or the mobile object itself. The mobile object means a movable object. A speed of the mobile object is changeable. The mobile object can stop. Examples of the mobile object include vehicles, transport vehicles, automobile, motorcycles, bicycles, connected cars, excavators, bulldozers, wheel loaders, dump trucks, forklifts, trains, buses, rear carriages, rickshaws, ships (including ships and other watercrafts), aircrafts, rockets, satellites, drones (registered trademark), multicopters, quadcopters, balloons, and objects mounted thereon. The examples are not limited thereto. The mobile object may run autonomously based on operational commands. The mobile object may be a vehicle (e.g., a car, an airplane), an unmanned mobile object (e.g., a drone, a self-driving car), or a robot (manned or unmanned). The mobile station includes a device that does not necessarily move during communication. For example, the mobile station may be an Internet of Things (IoT) device, such as a sensor.

(13) In the first and second embodiments, and the first to third modifications, the term “determining” may encompass a wide variety of actions. For example, the term “determining” may be used when practically “determining” that some act of calculating, computing, processing, deriving, investigating, looking up (for example, looking up a table, a database, or some other data structure), ascertaining and so forth has taken place. The term “determining” may be used when practically “determining” that some act of receiving (for example, receiving information), transmitting (for example, transmitting information), inputting, outputting, accessing (for example, accessing data in a memory) and so forth has taken place. Furthermore, “determining” may be used when practically “determining” that some act of receiving (for example, receiving information), transmitting (for example, transmitting information), inputting, outputting, accessing (for example, accessing data in a memory) and so forth has taken place. That is, “determining” may be used when practically determining to take some action. The term “determining” may be replaced with “assuming”, “expecting”, “considering”, etc.

(14) In the first and second embodiments, and the first to third modifications, the term “connected,” or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access.” As used in this specification, two elements may be considered “connected” or “coupled” to each other by using one or more electrical wires, cables and/or printed electrical connections, and to name a number of non-limiting and non-inclusive examples, by using electromagnetic energy, such as electromagnetic energy having wavelengths in radio frequency regions, microwave regions and optical (both visible and invisible) regions.

(15) In the first and second embodiments, and the first to third modifications, the phrase “based on” as used in this specification does not mean “based only on”, unless specified otherwise. In other words, the phrase “based on” means both “based only on” and “based at least on.”

(16) Any reference to elements using designations, such as “first” and “second” used in this specification, is not limited to quantity or order of the elements in general. These designations may be used in this specification as a convenient way to distinguish between two or more elements. Thus, references to the first and second elements do not mean that only two elements may be employed or that the first element must precede the second element in any way.

(17) In the first and second embodiments, and the first to third modifications, as long as terms such as “include”, “including” and modifications of these are used in this specification or in claims, these terms are intended to be inclusive, in a manner similar to the way the term “comprising” is used. Furthermore, the term “or” as used in this specification or in claims is not intended to be an exclusive disjunction.

(18) In this application, when articles such as, for example, “a”, “an” and “the” are added in the English translation, these articles may also indicate plural forms of words, unless the context clearly indicates otherwise.

(19) It should be obvious to one skilled in the art that this invention is by no means limited to the embodiments described in this specification. This disclosure can be implemented with a variety of changes and modifications, without departing from the spirit and scope of the present invention defined as in the recitations of the claims. Consequently, the description in this specification is provided only for the purpose of explaining examples and should by no means be construed to limit this invention in any way. Two or more aspects selected from aspects recited in this specification may be combined.

### DESCRIPTION OF REFERENCE SIGNS

1, 2: Information processing system, 10A, 10B: Pair of AR glasses, 20A, 20B: Mobile apparatus, 30: Inertia measurement device, 121: Projector, 122: Sound output device, 123, 203: Communication device, 124A: First image capture device, 124B: Second image capture device, 125, 205: Memory device, 126, 206: Processor, 127, 207: Bus, 128: Infrared light emitting device, 130: Operation controller, 201: Touch panel, 230A: First acquirer, 230B: Second acquirer, 231A: First generator, 231B: Second generator, 232: Image processor, 233: Notifier, 234: Eye tracker, DV (DV1, DV2): Apparatus, LEN: Imaging lens, LM: Trained model, PC: Captured image, PS: Partial image.

1. An information processing apparatus, comprising:
an acquirer configured to acquire:
movement information about movement of a user to which an image capture device is mounted at the head of the user, and
image information indicating an image captured by the image capture device;
a generator configured to:
control a position in the captured image, at which the captured image is partially cropped, in accordance with the movement information; and
generate, by controlling the position in the captured image, a partial image cropped from the captured image; and
an image processor configured to perform image processing on the partial image.

2. The information processing apparatus according to claim 1, wherein:
the acquirer is configured to acquire, as the movement information, information about movement of the head of the user, and
the generator is configured to generate the partial image by cropping a region showing an object previously designated, from the captured image in accordance with the information about the movement of the head.

3. The information processing apparatus according to claim 2, wherein:
the acquirer is configured to acquire the information about the movement of the head, from an inertia measurement device or a geomagnetic sensor mounted at the head of the user.

4. The information processing apparatus according to claim 1, wherein:
the acquirer is configured to acquire, as the movement information, eye information about movement of eyes of the user, and
the generator is configured to generate the partial image by cropping from the captured image a region out of a region in which predetermined information is recognizable by the user, based on the eye information.

5. The information processing apparatus according to claim 4, wherein:
the generator is configured to identify a position of a viewpoint of the user, based on the eye information, and
the generator is configured to crop as the partial image a portion separated from the viewpoint by a predetermined distance or more.

6. The information processing apparatus according to claim 4, wherein:
the partial image includes a first partial image and a second partial image,
a degree of gazing at the first partial image by the user is different from a degree of gazing at the second partial image by the user,
the generator is configured to identify a position of a viewpoint of the user, based on the eye information,
the generator is configured to crop the first partial image and the second partial image, based on a distance from the position of the viewpoint, and
image processing to be performed on the first partial image by the image processor differs from that on the second partial image by the image processor.
